(19) United States
(12) Patent Application Publication
(10) Pub. No.: US 2009/0091248 A1
(43) Pub. Date: Apr. 9, 2009

(54) White organic light emitting device

(76) Inventors: Mu-gyeom Kim, Yongin-si (KR); Sang-yeol Kim, Yongin-si (KR); Sung-hun Lee, Yongin-si (KR); Jung-bae Song, Yongin-si (KR)

Correspondence Address: ROBERT E. BUSHNELL & LAW FIRM, 2029 K STREET NW, SUITE 600, WASHINGTON, DC, 20006-1004, US

(21) Appl. No.: 12/155,744

(22) Filed: Jun. 9, 2008

(30) Foreign Application Priority Data
Oct. 8, 2007 (KR) 10-2007-0100892

(51) Int. Cl. H01J 1/62

(52) U.S. Cl. 313/504

(57) ABSTRACT

A white organic light emitting device (OLED) includes a pair of independent electrodes, a common electrode positioned between the independent electrodes, and a pair of white emission units respectively positioned at both sides of the common electrode in a mirror symmetry and emitting white light.

### CLAIM OF PRIORITY

This application makes reference to, incorporates the same herein, and claims all benefits accruing under 35 U.S.C. §119 from an application for WHITE ORGANIC LIGHT EMITTING DEVICE earlier filed in the Korean Intellectual Property Office on 8 Oct. 2007 and there duly assigned Serial No. 10-2007-0100892.

### BACKGROUND OF THE INVENTION

1. Field of the Invention

The present invention relates to a white organic light emitting device, and more particularly, to a white organic light emitting device (OLED) reducing driving voltages and improving the efficiency and lifetime of the white OLED.

2. Description of the Related Art

Generally, organic light emitting devices (OLEDs) are spontaneous emission devices that emit light by recombination of holes supplied by an anode and electrons supplied by a cathode in an organic light emitting layer formed between the anode and the cathode. Such OLEDs are light emitting devices that maybe widely applied to televisions (TVs), personal computer (PC) monitors, mobile communication terminals, MP3 players, and navigators installed in an automobile due to the advantages of high color reproducibility, fast response speed, spontaneous emission, small thickness, high contrast ratio, wide viewing angle and low power consumption. Meanwhile, OLEDS may also be used in indoor and outdoor illumination or signs.

Recently, the development of an OLED for a display has been briskly made, and in particular, the development of a white light emitting device has been concerned.

A white OLED is an organic light emitting device emitting white light and may be used in various fields such as thin light sources, backlights of liquid crystal displays (LCD) and full color display devices employing color filters.

Meanwhile, in order to improve luminous efficiency in a white OLED, many types of stack structures in which several unit OLEDs are vertically and serially connected with each other have been studied. In general, in case of a serially-connected stack structure, efficiency and lifetime may be improved while a higher driving voltage may be required, and a color variousness is increased according to an angle and a grayscale.

### SUMMARY OF THE INVENTION

It is therefore one object of the present invention to provide Exemplary embodiments are an improved white organic light emitting device in order to overcome the disadvantages stated above.

It is another object of the present invention to provide a white organic light emitting device (OLED) which may minimize a voltage change and improves efficiency and lifetime by combining a pair of emission units in parallel to face each other in a mirror symmetry based on a common electrode.

According to an exemplary embodiment of the present invention, there is provided a white organic light emitting device, the device including a pair of independent electrodes; a common electrode positioned between the pair of independent electrodes; and a pair of white emission units being respectively positioned at both sides of the common electrode in a mirror symmetry and emitting white lights.

Each of the white emission units may include red, green, and blue emission layers.

Each of the white emission units may further include at least one of a HIL (hole injection layer), a HTL (hole transport layer), an EIL (electron injection layer), an ETL (electron transport layer), a HSL (hole suppression layer), and an ESL (electron suppression layer).

One of the pair of independent electrodes may be a transparent electrode or a semitransparent electrode, and the other one thereof may be a reflective electrode. The common electrode may be a transparent electrode or a semitransparent electrode.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic cross-sectional view of a white organic light emitting device (OLED) constructed as an embodiment of the present invention; and

FIG. 2 is a schematic cross-sectional view of white emission units constructed as an embodiment of the present invention.

### DETAILED DESCRIPTION OF THE INVENTION

The invention is described more fully hereinafter with reference to the accompanying drawings, in which embodiments of the invention are shown. This should not be construed as limiting the claims to the embodiments shown. Rather, these embodiments are provided to convey the scope of the invention to those skilled in the art. In the drawings, the size and relative sizes of elements and regions may be exaggerated for clarity.

It will be understood that when an element or layer is referred to as being “on”, “interposed”, “disposed”, or “between” another element or layer, the element or layer may be directly on, interposed, disposed, or between the another element or layer, or intervening elements or layers may be presented between the element or layer and the another element or layer.

The terms “first,” “second,” and the like, and “primary,” “secondary,” and the like, as used herein do not denote any order, quantity, or importance, but rather are used to distinguish one element, region, component, layer, or section from another. The terms “front”, “back”, “bottom”, and/or “top” are used herein, unless otherwise noted, merely for convenience of description, and are not limited to any one position or spatial orientation.

The terms “a” and “an” do not denote a limitation of quantity, but rather denote the presence of at least one of the referenced item. The suffix “(s)” as used herein is intended to include both the singular and the plural of the term that it modifies, thereby including one or more of that term (e.g., the layer(s) includes one or more layers).

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

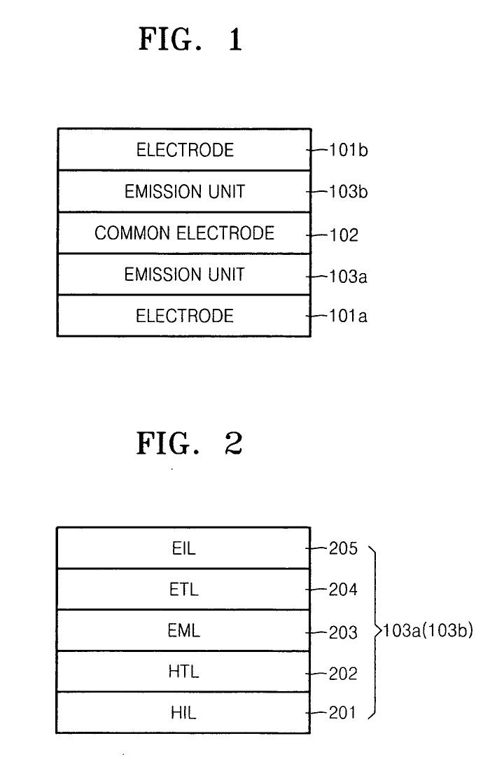

FIG. 1 is a schematic cross-sectional view of a white organic light emitting device (OLED) constructed as an embodiment of the present invention. Referring to FIG. 1, in the white OLED constructed as the current embodiment of the present invention, a common electrode 102 is disposed between a pair of independent electrodes 101a and 101b, and a pair of white emission units 103a and 103b are disposed to face each other in a mirror symmetry based on common electrode 102, i.e., symmetrically according to common electrode 102.

Independent electrodes 101a and 101b maybe respectively positioned at both ends of the white OLED, and one of independent electrodes 101a and 101b maybe formed on a substrate (not shown). In order to transmit light emitted from white emission units 103a and 103b, at least one of independent electrodes 101a and 101b may be formed of a transparent or semitransparent conductive material. For effective light transmission, the transmissivity of independent electrodes 101a and 101b may be 70% or higher. For example, independent electrodes 101a and 101b may be formed of indium tin oxide (ITO), indium zinc oxide (IZO), tin oxide (SnO2), zinc oxide (ZnO) etc. In order to proceed light emitted from two white emission units 103a and 103b in one direction, one of independent electrodes 101a and 101b may be a transparent electrode or a semitransparent electrode, and the other one thereof may be a reflective electrode. Examples of materials used for the reflective electrode includes lithium (Li), magnesium (Mg), aluminum (Al), aluminum-lithium (Al—Li), calcium (Ca), magnesium-indium (Mg—In), magnesium-silver (Mg—Ag) etc. Independent electrodes 101a and 101b may be driven separately and may also be driven by one unit by connecting a resistor therebetween. Common electrode 102 between white emission units 103a and 103b may be formed of a transparent material having high conductivity and high work function, like independent electrodes 101a and 101b. When independent electrodes 101a and 101b are used as an anode, common electrode 102 may be a cathode and vice versa is possible. Common electrode 102 may be grounded and an alternating current (AC) voltage maybe applied between independent electrodes 101a and 101b.

FIG. 2 is a schematic cross-sectional view of white emission units constructed as an embodiment of the present invention.

White emission units 103a and 103b may be formed to face each other in a mirror symmetry based on common electrode 102, i.e., maybe formed in a stack structure in which white emission units 103a and 103b are symmetrically formed based on common electrode 102. Each of white emission units 103a and 103b includes one white emission layer (EML) 203. White EML 203 may include two complementary color emission layers (not shown) or three primary colors (green, blue, and red) emission layers (not shown). In order to implement various colors using a color filter, white EML 203 may include one red emission layer, one green emission layer, and one blue emission layer (not shown).

White emission units 103a and 103b may further include a hole injection layer (HIL) 201 and an electron injection layer (EIL) 205 for facilitating injection of holes or electrons from the anode or the cathode, a hole transport layer (HTL) 202 and an electron transport layer (ETL) 204 for stably transporting holes from anode or electrons from the cathode, and a hole suppression layer (not shown) and an electron suppression layer (not shown) for preventing the holes or the electrons transported to each emission layer from being dispersed to the outside. The detailed structure of white emission units 103a and 103b will now be described with reference to FIG. 2.

Referring to FIG. 2, white emission units 103a and 103b may be a structure in which a hole injection layer (HIL) 201, a hole transport layer (HTL) 202, a white emission layer (EML) 203, an electron transport layer (ETL) 204, and an electron injection layer (EIL) 205 are sequentially stacked in order. The stack structure of white emission units 103a and 103b is shown as one example, and the present invention is not limited to this.

Well known material, for example, a phthalocyanine compound such as copper phthalocyanine, TCTA, m-MTDATA, m-MTDAPB and MoO3 which are Starburst type amine derivative, Pani/DBSA(Polyaniline/Dodecylbenzenesulfonic acid) or PEDOT/PSS(Poly(3,4-ethylenedioxythiophene)/Poly(4-styrenesulfonate), Pani/CSA(Polyaniline/Camphor sulfonicacid) or PANI/PSS(Polyaniline), Poly(4-styrenesulfonate) which is a conductive polymer having solubility may be used as a material of HIL 201.

The thickness of HIL 201 may be approximately in range of 100 Å-10000 Å, preferably, in approximately range of 100 Å-1000 Å. If the thickness of HIL 201 is less than 100 Å, the characteristic of HIL 201 may be deteriorated, and if the thickness of HIL 201 is greater than 10000 Å, a driving voltage may be increased.

Well known material, for example, carbazole derivative such as N-phenylcarbazole or polyvinylcarbazole and contemporary amine derivative having an aromatic condensed ring such as N,N′-bis(3-methylphenyl)-N,N′-diphenyl-[1,1-biphenyl]-4,4′-diamine(TPD), N,N′-di(naphthalene-1-yl)-N,N′-diphenyl benzidine(a-NPD) may be used as a material of HTL 202.

The thickness of HTL 202 may be approximately in range of 50 Å-1000 Å, preferably, in range of 100 Å-600 Å. If the thickness of HTL 202 is less than 50 Å, the characteristic of HTL 202 may be deteriorated, and if the thickness of HTL 202 is greater than 1000 Å, a driving voltage may be increased.

White EML 203 maybe formed on HTL 202, and each unit emission layer of white EML 203 maybe formed using a fluorescence or phosphorescence material as a dopant in a host material. In this case, the host material used to form each emission layer may be the same for blue, red, and green emission layers, and a host material used to form green and red emission layers may be a different material from the host material used in forming a blue emission layer. All materials used for a low molecular organic light emitting device such as AND, TBADN, and Alq3 etc. may be used as the host materials. A blue dopant used for a blue emission layer is not specially limited, and DPAVBi, DPAVBi derivative, distyrylarylene (DSA), distyrylarylene derivative, distyrylbenzene (DSB), distyrylbenzene derivative, spiro-DPVBi spiro-6P(spiro-sexyphenyl), or the like maybe used as blue dopant. A red dopant used for a red emission layer is not limited. 4-(dicyanomethylene)-2-t-butyl-6-(1,1,7,7-tetramethyljulolidyl-9-enyl)-4H-pyran;DCJTB), PtOEP and RD 61 made by UDC corporation may be used as the red dopant. Green dopant used for a green emission layer is not limited. Coumarin, Ir(PPy)3(PPy=2-phenylpyridine) or the like may be used as green dopant.

A material used to stably transport electrons injected from a cathode may be used for ETL 204. Well known materials, for example, an oxazole-based compound, an isoxazole-based compound, a triazole-based compound, an isothiazole-based compound, an oxadiazole-based compound, a thiadiazole-based compound, aperylene-based compound, an aluminum complex (i.e., Alq3 (tris(8-quinolinolato)-aluminium) BAlq, SAlq, Almq3 or a gallium complex (i.e., Gaq′2OPiv, Gaq′2OAc, 2(Gaq′2)) may be used as the material used for ETL 204.

The material used for EIL 205 is not limited, and a material used to easily facilitate injection of electrons from a cathode electrode may be used for EIL 205. Well known materials, for example, LiF, NaCl, CsF, Li2O, BaO, BaF2 and a mixture of CsCO3 and BCP may be used to form EIL 205. Conditions for depositing EIL 205 maybe varied according to compounds but may be almost the same as conditions for forming HIL 201.

In the white OLED constructed as the present invention, a pair of emission units are combined in parallel to face each other in a mirror symmetry based on a common electrode and are driven by a driving voltage of a single device such that efficiency may be improved. Thus, an electrical stress applied to the device is reduced such that the lifetime of the device may be improved. Since each of the driving voltages for the emission units 103a and 103b is independently applied, the total supplied voltage is equal to each of the driving voltages for the emission layers. With contemporary designs however, if the stacked structure includes no common electrode, the total voltage should be set to be twice the driving voltage for each emission layer, and the total voltage should be set to be twice the driving voltage for each emission layer, and the total voltage should be applied to the outermost electrodes in which two emission layers are connected electrically in series. In embodiments of the present invention, the common electrode is interposed between the emission layers, and therefore the driving voltage can be separately applied to each of the emission layers. Consequently, the efficiency of the OLED is improved by lowering the total voltage, which is made possible by the symmetrical configuration of the white organic light emitting device that may be constructed as embodiments of the present invention.

It will be obvious that the embodiments described above may be varied in many ways. Such variations are not to be regarded as a departure from the intended spirit and scope of the present invention, and all such modifications as would be obvious to one skilled in the art are intended to be included within the scope of the following claims.

What is claimed is:

1. A white organic light emitting device, comprising:
a pair of independent electrodes;
a common electrode disposed between the pair of independent electrodes; and
a pair of white emission units respectively disposed at both sides of the common electrode in a mirror symmetry based on the common electrode, and the pair of white emission units emitting white lights.

2. The device of claim 1, in which one of the pair of independent electrodes is one selected from a transparent electrode and a semitransparent electrode, and the other one thereof is a reflective electrode.

3. The device of claim 1, in which the pair of independent electrodes are connected to each other in the state where a resistor is disposed therebetween with the resistor being electrically connected to both of the pair of independent electrodes.

4. The device of claim 1, in which the common electrode is one selected from a transparent electrode and a semitransparent electrode.

5. The device of claim 1, in which each of the white emission units comprises red, green, and blue emission layers.

6. The device of claim 5, in which each of the white emission units further comprises at least one of a HIL (hole injection layer), a HTL (hole transport layer), an EIL (electron injection layer), an ETL (electron transport layer), a HSL (hole suppression layer), and an ESL (electron suppression layer).

7. A white organic light emitting device, comprising:
a common electrode;
a pair of independent electrodes respectively disposed at both sides of the common electrode in a mirror symmetry based on the common electrode, with the pair of independent electrodes being outer layers of the white organic light emitting device and being physically contacted to an exterior of the white organic light emitting device; and
a pair of white emission units respectively disposed at both sides of the common electrode in the mirror symmetry based on the common electrode, with the pair of white emission units emitting white lights.
